(19) United States
(12) Patent Application Publication
(10) Pub. No.: US 2015/0100874 A1
(43) Pub. Date: Apr. 9, 2015

(54) UI TECHNIQUES FOR REVEALING EXTRA MARGIN AREA FOR PAGINATED DIGITAL CONTENT

(71) Applicant: barnesandnoble.com llc, New York, NY (US)

(72) Inventors: Matthew Pallakoff, Mountain View, CA (US); Charles Neugebauer, Los Altos, CA (US); Lutz Gerhard, Seattle, WA (US); Luis D. Mosquera, Foster City, CA (US); David Gates, Palo Alto, CA (US)

(73) Assignee: barnesandnoble.com llc, New York, NY (US)

(21) Appl. No.: 14/046,554

(22) Filed: Oct. 4, 2013

(51) Int. Cl. G06F 17/24; G06F 3/01; G06F 17/21; G06F 3/0354

(52) U.S. Cl. CPC G06F 17/241; G06F 3/03545; G06F 3/017; G06F 17/217
USPC 715/232

(57) ABSTRACT

Techniques are disclosed for revealing extra margin area for paginated digital content, referred to herein as an extra margins mode. For example, the extra margins mode may be used to reveal/expose extra margin area (galley area) at the perimeter of one or more pages of an eBook or a photo of a photo album. Once galley area is exposed, a user can add content to the galley area, such as annotations using a stylus. In some cases, the extra margins mode may be configured to expose galley area for one or more pages in response to a reveal command input, such as a pinch gesture, a drag gesture, or an inward flick gesture from near the edge of a page using a stylus. The extra margins mode may also be configured to hide exposed galley areas in response to a hide command input, such as spread gesture.

### FIELD OF THE DISCLOSURE

This disclosure relates to electronic touch sensitive devices, and more particularly, to user interface (UI) techniques for interacting with paginated digital content on such devices.

### BACKGROUND

Electronic touch sensitive devices such as tablets, eReaders, mobile phones, smart phones, personal digital assistants (PDAs), and other such devices are commonly used for displaying digital content. The content may be, for example, an eBook, a web page, an online article or blog, images, a movie or video, a map, just to name a few types. Such devices may also be useful for displaying a user interface that allows a user to interact with one or more applications running on the device. The applications may allow a user to read or browse through paginated digital content, such as electronic books (eBooks), magazines, catalogs, or comics, for example. The user may interact with the electronic touch sensitive device using fingers and/or a stylus, for example. The use of a stylus may enhance the user's experience when interacting with the touch sensitive device. For example, using a stylus may increase the user's input accuracy or comfort, especially when writing or drawing on a touch sensitive electronic device.

### BRIEF DESCRIPTION OF THE DRAWINGS

FIG. 1a illustrates an example electronic touch sensitive device having an extra margins mode configured in accordance with an embodiment of the present invention.

FIG. 1b illustrates an example stylus for use with an electronic touch sensitive device, in accordance with an embodiment of the present invention.

FIGS. 1c-d illustrate example configuration menu screen shots of the electronic touch sensitive device shown in FIG. 1a, in accordance with an embodiment of the present invention.

FIG. 2a illustrates a block diagram of an electronic touch screen device configured in accordance with an embodiment of the present invention.

FIG. 2b illustrates a block diagram of a communication system including the electronic touch sensitive device of FIG. 2a configured in accordance with an embodiment of the present invention.

FIGS. 3a-h collectively illustrate an example extra margins mode of an electronic touch sensitive device, in accordance with an embodiment of the present invention.

FIGS. 4a-b illustrate example galley area (extra margin area) sizes for the same eBook page, in accordance with multiple embodiments of the present invention.

FIGS. 5a-b illustrate an example galley area that can be used for paginated digital content that may be viewed in both landscape and portrait orientations, in accordance with an embodiment of the present invention.

FIG. 6 illustrates a method for providing an extra margins mode in an electronic touch sensitive device, in accordance with an embodiment of the present invention.

### DETAILED DESCRIPTION

Techniques are disclosed for revealing extra margin area for paginated digital content, referred to herein as an extra margins mode. For example, the extra margins mode may be used to reveal/expose extra margin area (galley area) at the perimeter of one or more pages of an eBook or a photo of a photo album. Once galley area is exposed at the perimeter of the one or more pages, a user can add content to the galley area, such as annotations using a stylus. In some cases, the extra margins mode may be configured to expose galley area for one or more pages in response to a reveal command input, such as a pinch gesture, a drag gesture, or an inward flick gesture from near the edge of the page using a stylus. The extra margins mode may also be configured to hide exposed galley areas in response to a hide command input, such as a spread gesture, a double tap gesture, or an outward flick gesture near the edge of the galley area using a stylus. Numerous other configurations and variations will be apparent in light of this disclosure.

General Overview

As previously explained, electronic touch sensitive devices such as tablets, eReaders, and smart phones are commonly used for displaying user interfaces and digital content. The user of such devices can typically consume the displayed digital content with relative ease. In some instances, the content being consumed, such as electronic books (eBooks), magazines, catalogs, comics, or other digital documents, may be divided into individual pages. Some applications or user interfaces of the devices provide the ability to write on or annotate the paginated content. However, such conventional techniques are typically confined to the original space provided for each page, which may lead to a diminished user experience.

Thus, and in accordance with one or more embodiments of the present invention, techniques are disclosed for revealing extra margin area for paginated digital content, referred to herein as an extra margins mode. The extra margins mode may be used with any paginated or similarly divided digital content such as, for example, eBooks, magazines, catalogs, comics, documents, notes, presentations, lecture materials, photo albums, and/or any other suitable paginated or similarly divided digital content. For example, the extra margins mode may be used to reveal/expose extra margin area, referred to herein as “galley” area, around or otherwise at the perimeter of one or more pages of an eBook or a photo of a photo album. Therefore, the galley area can seamlessly extend the page and allow users to write/draw continuously from the original page to the galley area (which is located outside of the original page layout). In this manner, the user can annotate on the paginated content (e.g., by writing or drawing notes) without being confined to the original margins surrounding the paginated content. Further, the extra margins mode can be used with paginated digital content acquired from a publisher or an online repository, or with user-generated content. Once galley area (extra margin area) is revealed/exposed for one or more pages (or other suitable digital content divisions), a user can add content to the galley area, such as virtual ink annotations/writing/drawings (e.g., using a stylus or finger), text or characters, images, hyperlinks, or any other suitable content as will be apparent in light of this disclosure.

In some embodiments, the extra margins mode may be configured such that galley area (extra margin area) is exposed for one or more pages in response to a user performing a reveal command input. The reveal command input may include a pinch gesture using two or more fingers, a drag gesture using one or more fingers, a double tap gesture, an inward flick gesture from near the edge of the page using a stylus, a stylus gesture performed in combination with manipulation of a stylus control feature (e.g., stylus flick inward in combination with a press-and-hold of the stylus side button), hovering over the touch screen for a specific duration, or any other suitable input as will be apparent in light of this disclosure. After the galley area has been exposed (e.g., using one or more reveal commands), the user can add content to the galley area, as previously described. The extra margins mode may also be configured to hide the exposed galley area in response to a hide command input. The hide command input may include a spread gesture using two or more fingers, a double tap gesture, an outward flick gesture near the edge of the extra margin area using a stylus, a stylus gesture performed in combination with manipulation of a stylus control feature (e.g., stylus flick outward in combination with a press-and-hold of the stylus side button), or any other suitable input as will be apparent in light of this disclosure.

In some embodiments, a user may be able to perform additional reveal commands to expose additional galley area (e.g., where the galley area is not a preset size), while in other embodiments, the galley area may be a preset size that seamlessly extends from at least a portion of a page, as will be discussed in more detail below. For example, the galley area may seamlessly extend around the entirety of one or more pages in a manner that maintains the proportions of the original page layout or display, as will be apparent in light of this disclosure. In some embodiments, the galley area may seamlessly extend around the entirety of a two page side-by-side layout of the paginated digital content (e.g., when viewing the content in a landscape device/display orientation). In such embodiments, the galley area may be preserved such that when the content is viewed in a single page layout (e.g., when viewing the content in a portrait device/display orientation), the galley area from the side-by-side layout is used, as will be apparent in light of this disclosure. In still other embodiments, the galley area may be on one or two or three margins/sides of the page.

In some embodiments, the extra margins mode as variously described herein may be configured at a global level (e.g., based on the UI settings of the device) and/or at an application level (e.g., based on the specific application being used to interact with the digital content). For example, the extra margins mode may be configured to be enabled for some applications and disabled for others. To this end, the extra margins mode may be user-configurable, hard-coded, or some combination thereof (e.g., where some aspects are user-configurable and others are hard-coded), as will be apparent in light of this disclosure. Further, the extra margins mode as variously described herein may be included initially with the UI (or operating system) of an electronic touch sensitive device or be a separate program/service/application configured to interface with the UI of such a device to incorporate the functionality of the extra margins mode as variously described herein. In some embodiments, the extra margins mode may come in the form of a computer program product (one or more non-transient computer readable mediums) that includes a plurality of instructions non-transiently encoded thereon to facilitate operation of an electronic device according to a process that includes the functionality of the mode as variously described herein.

As will be apparent in light of this disclosure, the extra margins mode may be used on any suitable electronic touch sensitive device, such as various smartphones, tablets, and eReaders. In such devices, user input (e.g., the input used to perform a reveal or hide command) may be referred to as contact or user contact for ease of reference. However, direct and/or proximate contact (e.g., hovering within a few centimeters of the touch sensitive surface) may be used to provide user input to the device, depending on the specific touch sensitive surface/interface being used. In other words, in some embodiments, the extra margins mode may be invoked even without physically touching the device or its touch sensitive surface/interface. Also note that the user contact (whether direct or proximate) may be provided by the user's hand or another suitable body part, or a stylus or some other suitable implement, for example. Numerous variations and configurations will be apparent in light of this disclosure.

Architecture and Configuration Examples

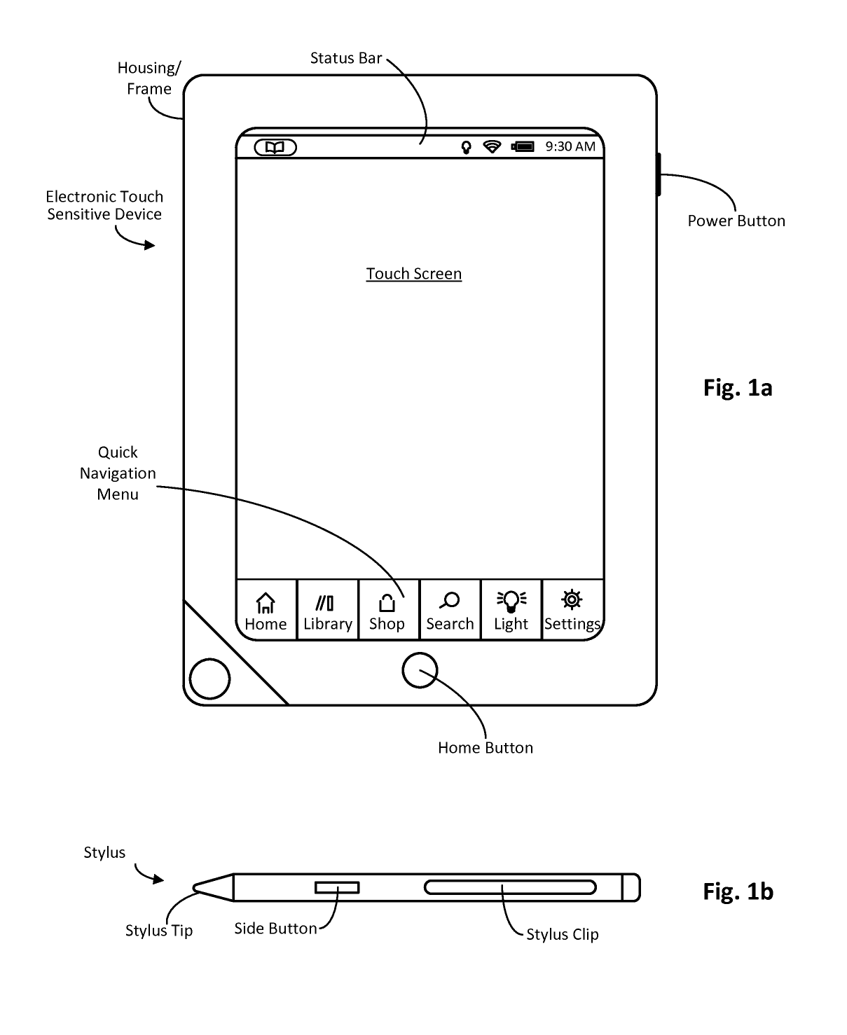

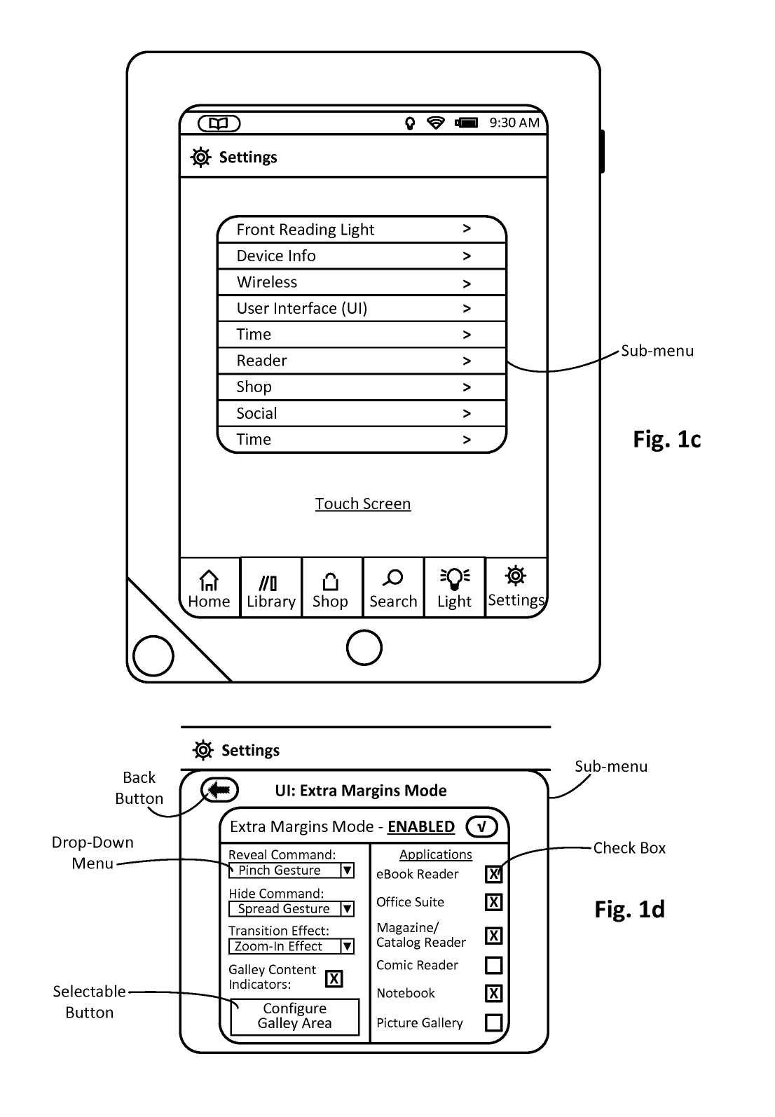

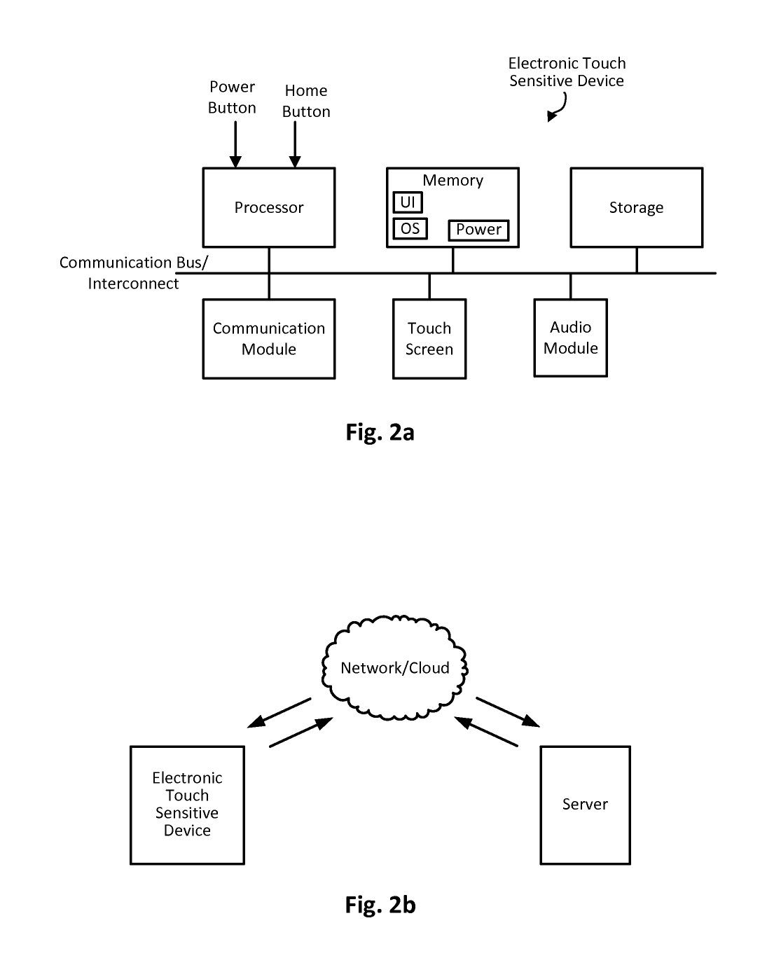

FIG. 1a illustrates an example electronic touch sensitive device having an extra margins mode configured in accordance with an embodiment of the present invention. The device could be, for example, a tablet such as the NOOK® tablet by Barnes & Noble®. In a more general sense, the device may be any electronic device having a touch sensitive user interface and capability for displaying content to a user, such as a mobile phone or mobile computing device such as an eReader or laptop, a desktop computing system, a television, a smart display screen, or any other device having a touch screen display or a non-touch display screen that can be used in conjunction with a touch sensitive surface. As will be appreciated, the claimed invention is not intended to be limited to any particular kind or type of electronic device. For ease of description, an example device is provided herein with touch screen technology.

The touch sensitive interface (touch sensitive display or touch screen in this example) can be any display that is configured with user input detecting technologies, whether capacitive, resistive, acoustic, active-stylus, and/or other input detecting technology. The screen display can be layered above input sensors, such as a capacitive sensor grid (e.g., for passive touch-based input, such as with a finger or passive stylus in the case of a so-called in-plane switching (IPS) panel), or an electro-magnetic resonance (EMR) sensor grid (e.g., for active stylus-based input). In some embodiments, the touch screen display can be configured with a purely capacitive sensor, while in other embodiments the touch screen display may be configured to provide a hybrid mode that allows for both capacitive input and active stylus input (e.g., using EMR technology). In still other embodiments, the touch screen display is configured with only an active stylus sensor. Numerous touch screen display configurations can be implemented using any number of known or proprietary screen based input detecting technology. In any such embodiments, a touch screen controller may be configured to selectively report contacts detected directly on or otherwise sufficiently proximate to (e.g., within a few centimeters) the touch screen display. Thus, in some such embodiments, the touch screen controller can be configured to interpret inputs from only a capacitive input, only an active stylus input, or both.

As previously explained, the user input may be provided, for example, by a passive implement (e.g., finger or capacitive stylus) or an active stylus, depending on the configuration of the touch screen display. In one example embodiment, an active stylus input can be provided by an actual physical contact on a touch sensitive surface. However, in other embodiments, the active stylus input may involve the stylus hovering some distance above the touch screen display surface (e.g., one to a few centimeters above the surface, or even farther, depending on the sensing technology deployed in the touch screen display), but nonetheless triggering a response at the device just as if direct contact were provided. As will be appreciated in light of this disclosure, an active stylus as used herein may be implemented with any number of active stylus technologies, such as DuoSense® pen by N-trig® (e.g., wherein the active stylus utilizes a touch sensor grid of a touch screen display) or EMR-based pens by Wacom technology, or any other commercially available or proprietary active stylus technology. Further recall that the active stylus sensor in the electronic touch sensitive device may be distinct from an also provisioned touch sensor grid in the device. Having the touch sensor grid separate from the active stylus sensor grid allows the device to, for example, only scan for an active stylus input, a touch contact, or to scan specific areas for specific input sources, in accordance with some embodiments. In one such embodiment, the active stylus sensor grid includes a network of antenna coils that create a magnetic field which powers a resonant circuit within the active stylus. In such an example, the active stylus may be powered by energy from the antenna coils in the device and the stylus may return the magnetic signal back to the device, thus communicating the stylus' location, angle of inclination, speed of movement, etc. Such an embodiment also eliminates the need for a battery in the stylus, for example.

As can be seen with the example configuration shown in FIG. 1a, the device comprises a housing/frame that includes a number of hardware features such as a power button, control features, and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such user interface (UI) touch screen features, or different UI touch screen features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example device, the home button is a physical press-button that can be used to display the device's home screen when the device is awake and in use. In this example configuration, the home button is a physical press-button that can be used as follows: when the device is awake and in use, tapping the button will display the quick navigation menu, which is a toolbar that provides quick access to various features of the device. The home button may also be configured to cease an active function that is currently executing on the device, or close a configuration sub-menu that is currently open. The button may further control other functionality if, for example, the user presses and holds the home button. In some embodiments, the home button or other buttons (whether physical or virtual) may also be used in conjunction with the extra margins mode to, for example, hide the extra margins after they have been revealed or disable the extra margins mode, as will be discussed herein. Numerous other configurations and variations will be apparent in light of this disclosure, and the claimed invention is not intended to be limited to any particular set of control features or device form factor.

FIG. 1b illustrates an example stylus for use with an electronic touch sensitive device, in accordance with an embodiment of the present invention. As can be seen, in this particular example, the stylus includes a stylus tip used to interact with a touch sensitive device, e.g., through direct or proximate contact (e.g., by hovering over the device). In this example, the stylus tip has a triangular shape, while in other examples, the stylus tip may be more rounded, or any other suitable shape. The stylus tip may be made of any number of materials of different textures and firmness depending on the needs of the specific touch sensitive device. This example stylus configuration also includes a side button along the shaft of the stylus. However, the stylus may include fewer or additional control features or different control features altogether. The control features may be used in conjunction with the extra margins mode, for example, to reveal/hide extra margins as will be discussed herein. As previously described, the stylus may be a capacitive stylus or an active stylus, or any other suitable implement used to provide input to a touch sensitive electronic device. As was also described, in the case of an active stylus, the device may be able to distinguish between capacitive input (e.g., using one or more fingers) and active stylus input. Further, in such cases, the active stylus may be able to provide input in a proximate manner (e.g., without physically contacting the touch sensitive surface), for example using hovering input. Numerous stylus variations and configurations will be apparent in light of this disclosure.

FIGS. 1c-d illustrate example configuration menu screen shots of the electronic touch sensitive device shown in FIG. 1a, in accordance with an embodiment of the present invention. In one example embodiment, an extra margins mode configuration sub-menu, such as the one shown in FIG. 1d, may be accessed by tapping or otherwise selecting the Settings option in the quick navigation menu, which causes the device to display the general sub-menu shown in FIG. 1c. From this general sub-menu, the user can select any one of a number of options, including one designated User Interface (UI) in this specific example case. Selecting this sub-menu item (with an appropriately placed screen tap) may cause the configuration sub-menu of FIG. 1d to be displayed, in accordance with an embodiment. In other example embodiments, selecting the UI option may present the user with a number of additional sub-options, one of which may include a so-called extra margins mode option, which may then be selected by the user so as to cause the extra margins mode configuration sub-menu of FIG. 1d to be displayed. Any number of such menu schemes and nested hierarchies can be used, as will be appreciated in light of this disclosure. In other embodiments, the extra margins mode may be hard-coded such that no configuration sub-menus are needed or otherwise provided (e.g., an application specific extra margins mode as described herein, with no user configuration).

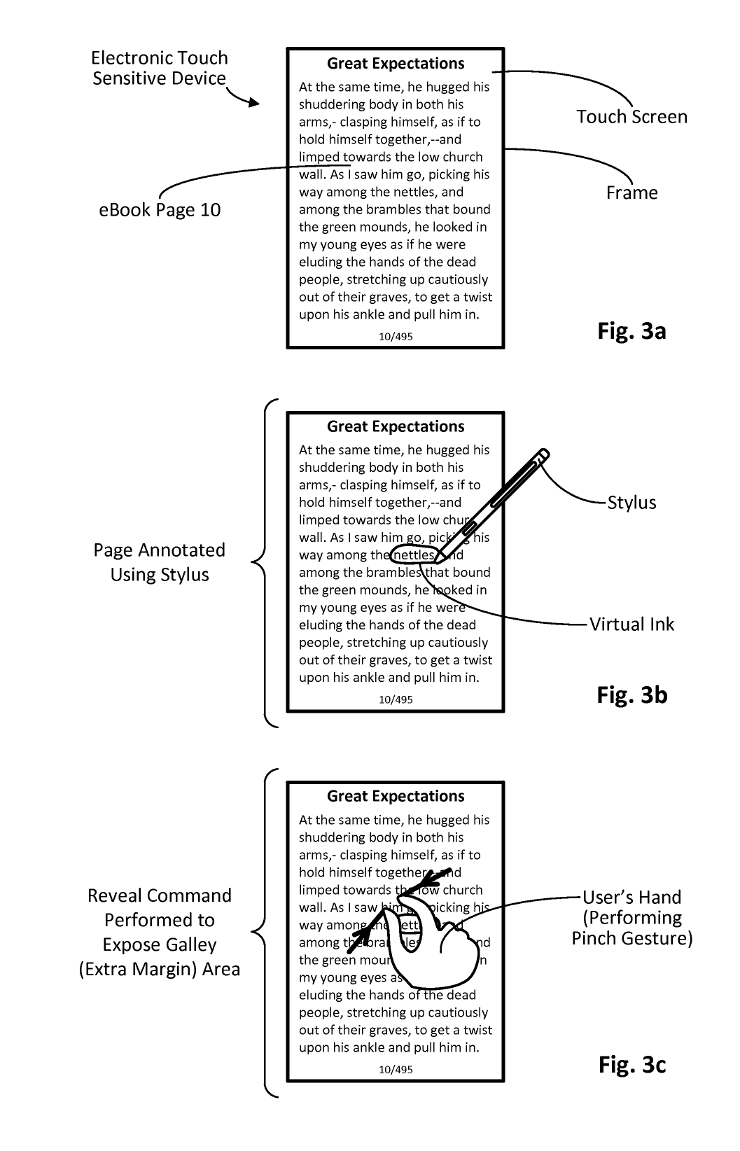

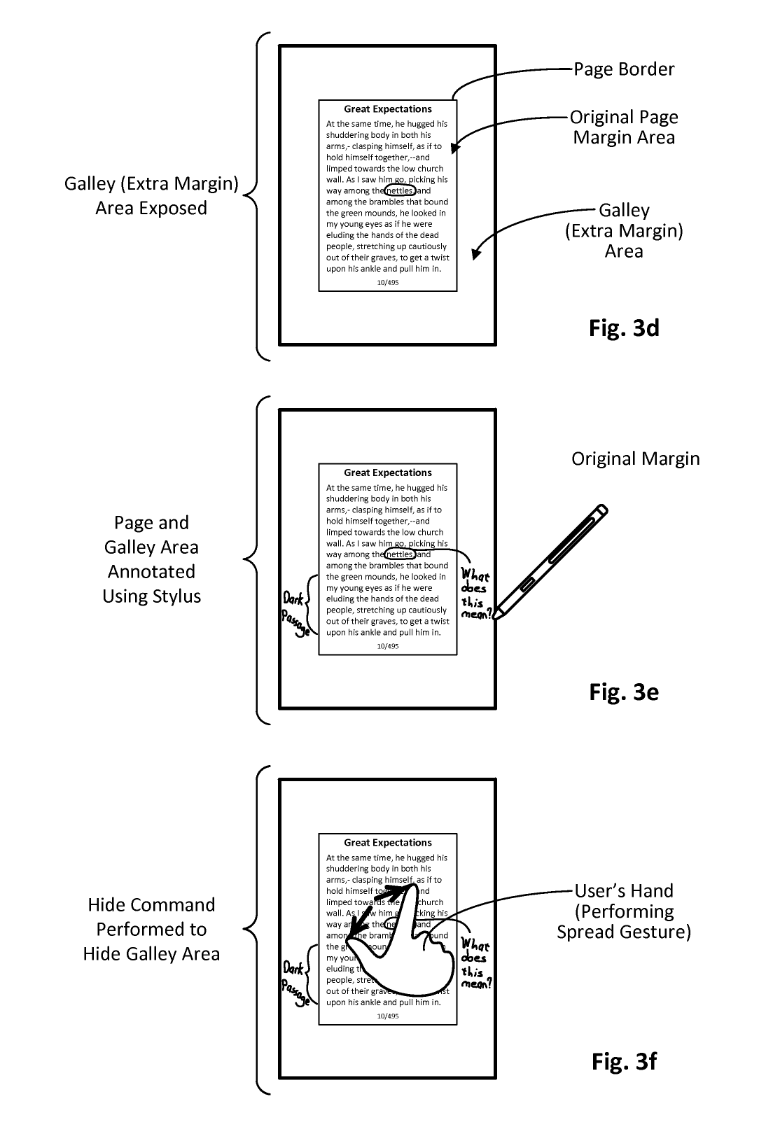

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). The user touch may be performed with a finger, a stylus, or any other suitable implement, unless otherwise specified. Additional example details of the underlying OS and circuitry in accordance with some embodiments will be discussed in turn with reference to FIG. 2a.

As previously explained, and with further reference to FIGS. 1c-d, once the Settings sub-menu is displayed (FIG. 1c), a user can then select the User Interface (UI) option. In response to such a selection, the Extra Margins Mode sub-menu shown in FIG. 1 d can be provided to the user and allow the user to configure a number of features with respect to the mode. In this example case, the configuration sub-menu includes a UI check box that when checked, or otherwise selected by the user, effectively enables the extra margins mode (shown in the enabled state); unchecking the box disables the mode. Other embodiments may have the extra margins mode always enabled, while in other embodiments the mode may be enabled or disengaged by a physical switch or button, or by a uniquely identifiable gesture or screen contact, for example.

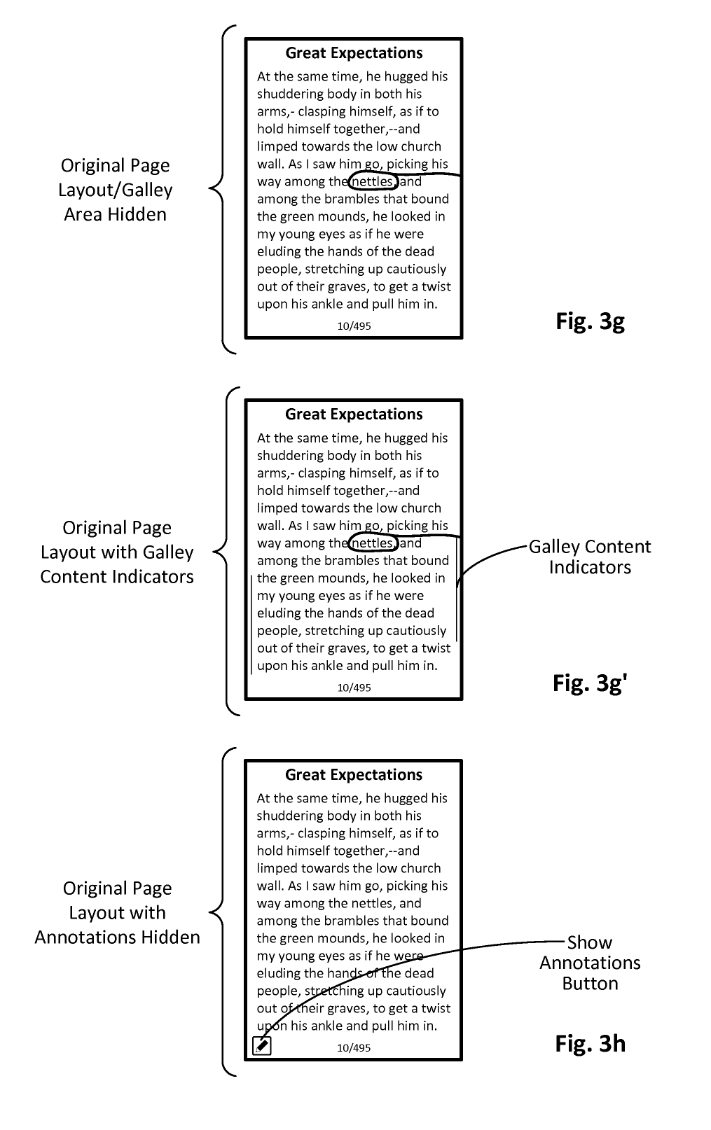

As can be seen in the example shown in FIG. 1d, the sub-menu includes a left side that allows a user to configure a number of options for the extra margins mode and a right side that allows a user to enable/disable the extra margins mode per application. The left side of the sub-menu includes a configuration option that allows a user to select one or more reveal command inputs using the corresponding drop-down menu. As previously described, an extra margins mode reveal command can be performed on a page of paginated content to expose a galley area (extra margin area) for at least a portion of the page. As shown, the ‘Reveal Command’ input is set at ‘Pinch Gesture’, which may be performed by initiating contact (direct or proximate) with two or more fingers and bringing them closer together. The pinch gesture reveal command input is illustrated in FIG. 3c and described in more detail below. Other example reveal command inputs may include a drag gesture using one or more fingers, a double tap gesture, an inward flick gesture from near the edge of the page using a stylus, a stylus gesture performed in combination with manipulation of a stylus control feature (e.g., stylus flick inward in combination with a press-and-hold of the stylus side button), hovering over the touch screen for a specific duration, or any other suitable input as will be apparent in light of this disclosure.

The next configuration option allows a user to select the hide command input using the corresponding drop-down menu. As previously described, the extra margins mode hide command can be performed on a page of paginated content having an exposed galley area (extra margin area) to hide the galley area and present the page in its original layout. As shown, the ‘Hide Command’ input is set at ‘Spread Gesture’, which may be performed by initiating contact (direct or proximate) with two or more fingers and moving them apart. The spread gesture hide command input is illustrated in FIG. 3f and described in more detail below. Other example hide command inputs may include a double tap gesture, an outward flick gesture near the edge of the extra margin area using a stylus, a stylus gesture performed in combination with manipulation of a stylus control feature (e.g., stylus flick outward in combination with a press-and-hold of the stylus side button), or any other suitable input as will be apparent in light of this disclosure. Note that the extra margins mode may be configured with more than one reveal command and more than one hide command (regardless of whether such commands are user-configured or hard coded). For example, the mode may be configured such that both a pinch gesture and a drag gesture can be used as reveal command inputs, and both a spread gesture and a stylus flick performed in combination with a press-and-hold of the stylus side button can be used as hide command inputs. In such an example, the mode may also be configured to recognize a double tap gesture on paginated digital content as both a reveal command (e.g., when the original page layout is shown) and a hide command (e.g., when galley area is shown).

The next configuration option relates to the transition effect used to show the galley area when turning to a page that includes content in its galley area. As shown, the ‘Transition Effect’ is set at ‘Zoom-In Effect’, which causes the page and galley area to be shown in its entirety when first turning to that page before zooming-in on only the page (in its original layout). Any other suitable transition effect may be used, while in some embodiments, there may be no transition effect at all. In other words, when a user first turns to a page that includes content in its galley area, the extra margins mode may be configured to always show the full page and galley area, or just the original page layout, until additional input is provided. The next configuration option, ‘Galley Content Indicators’, allows the user to enable/disable whether indicators are given to notify a user that a page includes content in its galley area (shown enabled). Such indicators may be visual, aural, or tactile, and can be provided when the page is presented in its original layout. An example of visual indicators for galley content is illustrated in FIG. 3g′ and described in more detail below.

The next configuration option relates to settings for the galley area (extra margin area). As shown, a ‘Configure Galley Area’ virtual button is provided to allow the user to adjust settings for the galley area itself. Selecting the virtual button may present another sub-menu, where the user can set the color of the galley area, the size of the galley area, which are just a few examples. Configuring the size of the galley area may include selecting whether the galley area is set at a pre-determined size or if it is expandable in response to additional reveal command inputs, for example. In cases where the galley area size is set at a pre-determined size, the galley area may seamlessly extend from the original page layout based on a percentage of the original page layout, based on a percentage of the display area, or based on a measured amount. As will be apparent in light of this disclosure, the extra margins area may be configured in some instances to automatically provide a seamless galley area around the entire original page layout in response to performing a reveal command, while in other instances, the galley area may only be extended from a portion of the original page. For example, the galley area may only extend from the side that the specific reveal command input is performed on (e.g., using a drag gesture on that specific side). Remember that other aspects or features of the extra margins mode may be user-configurable, and some of the configurable options described above may be hard-coded, depending upon the particular embodiment.

In some embodiments, the user may specify a number of applications or scenarios in which the extra margins mode is enabled. Such a configuration feature may be helpful, for instance, in a tablet, smart phone, laptop, or other multifunction computing device that can execute different applications (as opposed to a device that is more or less dedicated to a particular application). In this example case, the available applications are provided along with a corresponding check box as shown generally on the right side of the sub-menu in FIG. 1d. Note the diverse nature of the examples, including an ‘eBook Reader’ application, an ‘Office Suite’ application, a ‘Magazine/Catalog Reader’ application, a ‘Comic Reader’ application, a ‘Notebook’ application, and a ‘Picture Gallery’ application, which are just a few examples. In this particular example, the extra margins mode is enabled for the eBook Reader, Office Suite, Magazine/Catalog Reader, and Notebook applications. Any number of applications or device functions may benefit from an extra margins mode as variously provided herein, whether user-configurable or not, and the claimed invention is not intended to be limited to any particular application or set of applications.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen with a touch screen controller, and an audio module. A communications bus and interconnect is also provided to allow inter-device communication. Other typical componentry and functionality not reflected in the block diagram will be apparent (e.g., battery, co-processor, etc.). In any such cases, the touch screen surface is generally capable of translating a user's physical contact with the surface into an electronic signal that can be manipulated or otherwise used to trigger a specific user interface action, such as those provided herein. As stated previously, the principles provided herein equally apply to any electronic touch sensitive device. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The various modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 7 to 9 inch 1920×1280 IPS LCD touchscreen touch screen, or any other suitable display and touch screen interface technology. The communications module can be, for instance, any suitable 802.11b/g/n WLAN chip or chip set which allows for connection to a local network so that content can be downloaded to the device from a remote location (e.g., content provider, etc., depending on the application of the display device). In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc.). The device may be smaller, for example, for smartphone and tablet applications and larger for smart computer monitor applications.

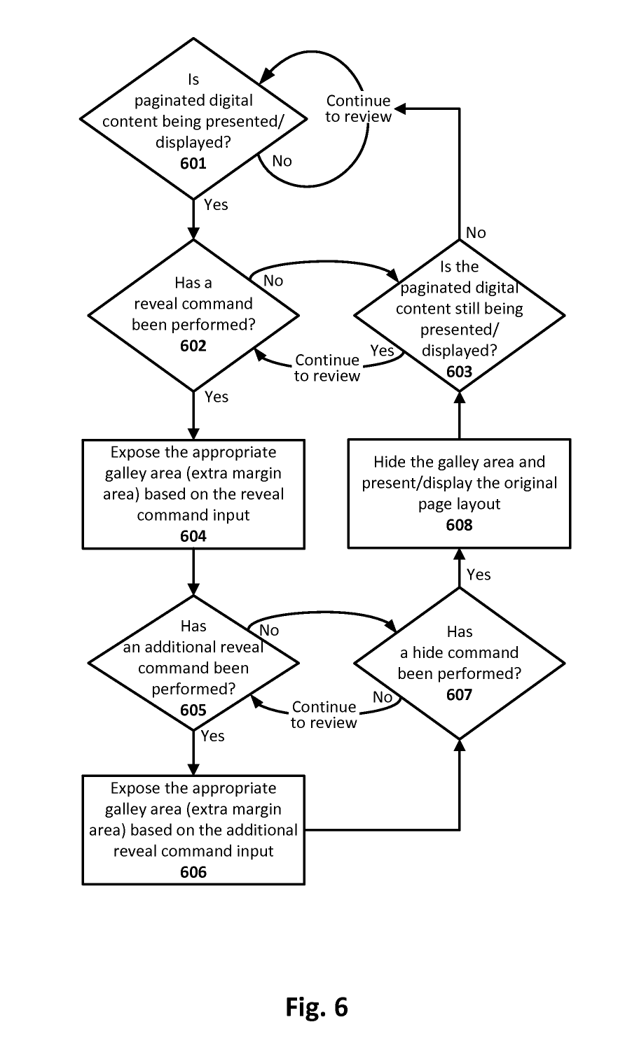

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touch screen technology and the various example screen shots shown in FIGS. 1a, 1c-d, and 3a-h, in conjunction with the extra margins mode methodologies demonstrated in FIG. 6, which will be discussed in turn.

The touch screen controller can be any suitable controller (e.g. the CYP658756 chip by Cypress), with sufficient hardware and/or software to implement the commands and inputs disclosed herein. In some embodiments, the touch screen controller may be able to distinguish between input from a finger and input from an active stylus, as will be apparent in light of this disclosure. The audio module can be configured, for example, to speak or otherwise aurally present a selected eBook table of contents or other textual content, if preferred by the user. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the electronic touch sensitive device of FIG. 2a configured in accordance with an embodiment of the present invention. As can be seen, the system generally includes an electronic touch sensitive device that is capable of communicating with a server via a network/cloud. In this example embodiment, the device may be, for example, an eReader, a smart phone, a laptop, a tablet computer, a desktop computer, or any other suitable electronic touch sensitive device. The network/cloud may be a public and/or private network, such as a private local area network operatively coupled to a wide area network such as the Internet. In this example embodiment, the server may be programmed or otherwise configured to receive content requests from a user via the electronic touch sensitive device and to respond to those requests by providing the user with requested or otherwise recommended content. In some such embodiments, the server may be configured to remotely provision an extra margins mode as described herein or an application having the functionality of the extra margins mode as described herein to the device (e.g., via JavaScript or other browser based technology). In other embodiments, portions of the methodology may be executed on the server and other portions of the methodology may be executed on the device. Numerous server-side/client-side execution schemes can be implemented to facilitate an extra margins mode in accordance with one or more embodiments, as will be apparent in light of this disclosure.

Extra Margins Mode Examples

FIGS. 3a-h collectively illustrate an example extra margins mode of an electronic touch sensitive device, in accordance with an embodiment of the present invention. As can be seen in FIG. 3a, the electronic touch sensitive device is shown having a housing/frame that includes a touch screen for displaying content and allowing user input (whether direct or proximate). The touch screen in FIG. 3a is displaying a page of an eBook, and more specifically, page 10 of the eBook “Great Expectations.” The eBook may be displayed or otherwise presented using an eReader application, or some other suitable application or program. Although the extra margins mode is being illustrated on a touch sensitive device having a touch screen, other touch sensitive devices may include a non-touch display screen that can be used in conjunction with a touch sensitive surface/interface, such as a track pad, as previously described. Further, in this example embodiment, the electronic touch sensitive device is configured to distinguish between capacitive input (e.g., provided by one or more fingers) and active stylus input (e.g., provided by a stylus using EMR technology).

FIG. 3b shows a user writing on the eBook page to annotate it with virtual ink using a stylus. More specifically, the user circled the word ‘nettles’ using the stylus. Although a stylus is being used to annotate the eBook page in this example embodiment, the page may also be annotated using a finger or other suitable implement in other embodiments. FIG. 3c shows the user performing a reveal command to expose galley area (extra margin area). As can be seen, the reveal command in this example embodiment is a pinch gesture (using two fingers of the user's hand) performed on the eBook page. As previously described, the reveal command may be performed using other input, such as a drag gesture using one or more fingers, a double tap gesture, an inward flick gesture from near the edge of the page using a stylus, a stylus gesture performed in combination with manipulation of a stylus control feature (e.g., stylus flick inward in combination with a press-and-hold of the stylus side button), hovering over the touch screen for a specific duration, or any other suitable input as will be apparent in light of this disclosure. Note that in embodiments where a drag gesture is used as the reveal command, such an input can be distinguished from a flick gesture (which may be used, for example, as a page turning input) to prevent disrupting the regular eBook reading experience.

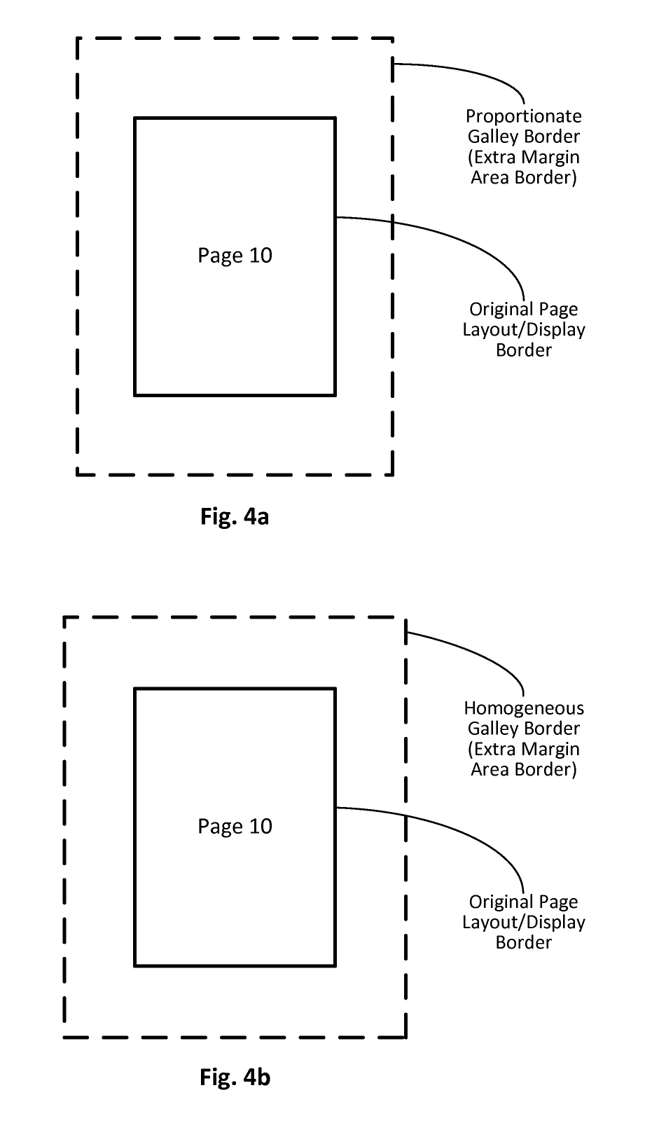

FIG. 3d shows the galley area (extra margin area) exposed at the perimeter of and around page 10 of the eBook. The galley area was exposed in response to the reveal command performed in FIG. 3c. The border for the original page layout is shown in this example embodiment to visually distinguish the original page layout from the galley area. However the page border need not be shown. As can be seen in this embodiment, the galley area around the original page layout is a seamless extension of the original page (or normal reading page) and not a distinct area next to or over the page. In this manner, the original page margin area, which may not allow much blank space for annotations (such as is the case for page 10 of the eBook shown), can be extended to allow extra margin area for user annotations and other content. The galley area shape and/or size may be based on the configuration of the extra margins mode, as will be discussed in more detail below with respect to FIGS. 4a-b and 5a-b.

FIG. 3e shows the page and galley area annotated by the user using a stylus. More specifically, the user has drawn a line from the previously circled word ‘nettles’ across the page and into the right side of the galley area, where the user wrote ‘What does this mean?’ in the galley area. In addition, the user drew a bracket near a passage of the text and wrote the phrase ‘Dark Passage’ in the left side of the galley area, as can be seen. In this manner, the user has added content to the galley area. Note that any type of suitable content may be added to the galley area once it has been exposed, such as drawings, annotations, text and other characters, photos, and hyperlinks, just to name a few examples. Also note that since the galley area is a seamless extension of the original page (or normal reading page) in the extra margin mode, the user can continuously write, draw, or annotate from the original page to the galley area or from the galley area to the original page, as illustrated in FIG. 3e.

FIG. 3f shows the user performing a hide command to hide the galley area (extra margin area). As can be seen, the hide command in this example embodiment is a spread gesture (using two fingers of the user's hand) performed on the eBook page. As previously described, the hide command may be performed using other input, such as a double tap gesture, an outward flick gesture near the edge of the extra margin area using a stylus, a stylus gesture performed in combination with manipulation of a stylus control feature (e.g., stylus flick outward in combination with a press-and-hold of the stylus side button), or any other suitable input as will be apparent in light of this disclosure. FIG. 3g shows the original page layout with the galley area hidden after the hide command of FIG. 3f was performed. As can be seen in FIG. 3g, the annotations added in FIG. 3e are still visible on the eBook page.

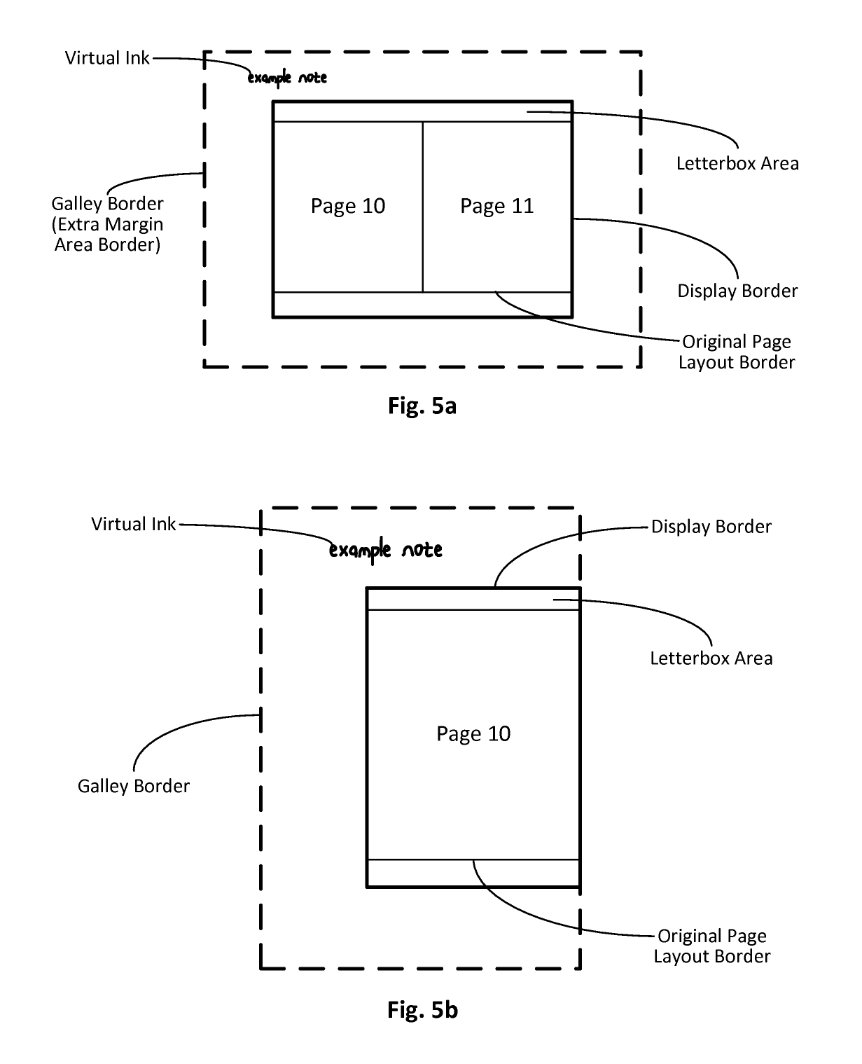

FIG. 3g′ shows another example of how the page may look after content has been added to the galley area and the galley area has been hidden. In this example, the extra margins mode is configured to add lines to the outside of the page to indicate that there is content in the galley area surrounding the page, as can be seen. Other suitable indicators may be used, such as changing the color of letterbox area that may surround a portion of the page (e.g., the letterbox surrounding the pages in FIGS. 5a-b), placing a single indicator on the page (e.g., a star in one corner), or continuing to show a small portion of the galley area, just to name a few examples. In some embodiments, the extra margins mode may be configured to indicate that a page has content in its galley area in other ways, such as with visual, aural, or tactic indications when the user first turns to the page, or distinguishing the pages that have content in their galley area in the table of contents from those that do not. For example, the extra margins mode may be configured in an example embodiment to display the page and its galley area for a duration of time when a user first turns to the page, and then zoom-in on the original page layout, if the page has content in its galley area. In another example embodiment, if the page has a galley area having content, the mode may be configured to play a sound when a user first turns to the page. Any suitable indication (or no indication) may be used as will be apparent in light of this disclosure.

FIG. 3h shows the original page layout with all annotations hidden. As can be seen, a show annotations button is provided in the lower left corner of the page to allow the user to turn the annotations back on. In some cases, when annotations are turned off, the user may not be able to use the extra margins mode, since the galley area is used to allow a user to add annotations (or other suitable content). In some embodiments, the user may be able to disable the extra margin mode without disabling annotation functionality. In such embodiments, disabling of the extra margin mode may erase the galley areas from every page, including the corresponding content in each galley area. Also note that the content added to the galley areas may be saved in a manner that adds the galley areas and corresponding content to the original file for the paginated digital content, or in a manner that saves the galley areas and corresponding content to a separate file that may be used in combination with the appropriate digital content file, depending upon the mode configuration. For example, using the “Great Expectations” eBook example shown in FIGS. 3a-h, the annotations added to page 10 of the eBook may be saved to the eBook's file (e.g., to the original .epub file, .pdf file, .doc file, etc.) or to a separate file that may be used with the original eBook file (e.g., loaded/opened after opening the original file).

As previously described, the galley area (extra margin area) may come in different shapes and/or sizes depending upon the configuration of the extra margins mode. FIGS. 4a-b illustrate example galley area (extra margin area) sizes for the same eBook page, in accordance with multiple embodiments of the present invention. For example, as shown in FIG. 4a, the size of the galley area is such that the galley area border is proportionate to the original page layout. In other words, the galley area may be seamlessly extended out from the original page layout in all directions by a preset percentage of the page or display size, such as 10%, 15%, 25%, 50%, 75%, 100%, or any other suitable amount. Using a specific example of extending the galley area out 25% of the original page layout in all directions would result in a galley border that is 1.5× as tall and 1.5× as wide as the original page layout, but still maintains the same proportions as the original page layout. In another example, as shown in FIG. 4b, the homogeneous galley area seamlessly extends the same amount from the edges of the page around the entirety of the original page layout. In other words, the galley area may extend out from the original page layout by anywhere from 1 cm to 10 cm, or any other suitable amount, around the entire page.

Although the galley area is shown extending seamlessly from all sides/portions of the original page layout in FIGS. 4a-b, the galley area need not extend in such a manner. In some embodiments, galley area may be exposed and/or created as the user drags in a certain direction from the original page layout, such that the user can perform a reveal command (e.g., a drag gesture) to only expose galley area on one side of the page, for example. Such a feature may be useful for maximizing display area when viewing the galley area content and it may be useful for reducing the amount of memory and/or storage used for the extra margins mode. Further, in some embodiments, the galley area need not be confined to a preset size and/or shape. For example, a user may be able to perform as many reveal commands as desired to add to the size of the galley area. The extra margins mode may be configured to allow any suitable galley area (extra margin area) that is a seamless extension of the original page, as will be apparent in light of this disclosure.

FIGS. 5a-b illustrate an example galley area that can be used for paginated digital content that may be viewed in both landscape and portrait orientations, in accordance with an embodiment of the present invention. More specifically, FIG. 5a illustrates an example galley area exposed for an eBook displayed in a landscape orientation, and FIG. 5b illustrates the example galley area exposed for the eBook shown in FIG. 5a displayed in a portrait orientation. Such a galley area can be used to accommodate a spread or side-by-side page layout, which may be used when viewing paginated digital content in a landscape orientation. As shown in FIG. 5a, two pages, pages 10 and 11, of an eBook are shown in a spread or side-by-side layout and the display border may be the frame of an electronic touch sensitive device, for example. The original page layouts do not fill the entire display area, resulting in letterbox areas above and below the pages. The galley border (extra margin area border) is also shown to illustrate the size of the galley area for these pages. As can be seen in FIG. 5a, the user has already exposed the galley area and written ‘example note’ in the top left section above eBook page 10.

As shown in FIG. 5b, when the user switches the orientation of the device (such that the display border is now in a portrait orientation), the device displays one page at a time (page 10 in this example case). In this example embodiment, the galley area from the landscape orientation was cut in half along the split of the eBook pages (e.g., between page 10 and 11), such that the same galley area can be used for each page regardless of the device/display orientation. As a result, the galley area shown in FIG. 5b only has extra margin area on the top, left, and bottom sides of page 10, but no galley are to the right of page 10, since that is where page 11 is located when the eBook is viewed in a landscape orientation. In this manner, content added to the galley area can be preserved no matter the orientation of the device (as can be seen with the ‘example note’ annotation). For completeness of description, if page 11 were displayed while the device is in a portrait orientation, the galley area (extra margin area) would only be located on the top, right, and bottom of the page. Numerous variations and configurations will be apparent in light of this disclosure.

Methodology

FIG. 6 illustrates a method for providing an extra margins mode in an electronic touch sensitive device, in accordance with an embodiment of the present invention. This example methodology may be implemented, for instance, by the UI module of the example electronic touch sensitive device shown in FIG. 2a, or the example device shown in FIG. 2b (e.g., with the UI provisioned to the client by the server). To this end, the UI may be implemented in software, hardware, firmware, or any suitable combination thereof, as will be appreciated in light of this disclosure. The electronic touch sensitive device may be able to detect contact, whether direct or proximate (e.g., via hovering input), which can be used in various ways to implement UI functionality, including performing a reveal command or a hide command as variously described herein.

In the example case illustrated in FIG. 6, the method starts by determining 601 if paginated digital content (or similarly divided digital content) is being presented/displayed. The paginated digital content may be presented/displayed using any appropriate application or program, such as an eReader application, an office application (e.g., document viewing application), a magazine/catalog reader application, or any other suitable application or program. If paginated digital content is not being displayed (or otherwise presented), the method continues to review until such content is displayed. In some embodiments, the extra margins mode may be tied to one or more applications capable of presenting/displaying paginated digital content and the mode may not be available until one such application is running, active, and/or displayed (which may result in a conservation of device power and/or memory). Once paginated digital content is being displayed, the method continues by determining 602 if a reveal command (as variously described herein) has been performed. If a reveal command has not been performed, the method continues by reviewing 603 if the paginated digital content is still being displayed. If the content is not still being displayed, the method starts back at diamond 601 to review if paginated digital content is being displayed. If the paginated digital content is still being displayed, the method continues to review until either a reveal command has been performed or until the content is no longer being displayed.

Once a reveal command has been performed on one or more pages of the content, the method continues by exposing 604 the appropriate galley area (extra margin area) based on the reveal command input. For example, if a pinch gesture, drag gesture, or double tap reveal command is performed, the mode may be configured to zoom out to present/display a preset galley area extending seamlessly from the original page layout. The user can then add content to the galley area, such as annotating in the galley area with a stylus as shown in FIG. 3e. The method continues by determining 605 if an additional reveal command has been performed to expose additional galley area. If an additional reveal command has been performed, then the method continues by exposing 606 the appropriate galley area (extra margin area) based on the additional reveal command input. Note that the extra margins mode may need to be configured to allow additional galley area to be exposed in response to an additional reveal command. If an additional reveal command has not been performed, the method continues by determining 607 if a hide command has been performed. If a hide command has not been performed, the method continues to review until either an additional reveal command has been performed or until a hide command has been performed. Note that diamonds 605 and 607 may be determined in reverse order in another embodiment.

Continuing from diamond 607, if a hide command has been performed, then the method continues by hiding 608 the galley area and presenting/displaying the original page layout. Note that if content was added to the galley area, then the original page layout may have galley content indicators to show that (and possibly where) content has been added. Also note that other actions and/or inputs may cause the galley content to be hidden, such as turning to another page, exiting from the application being used to present/display the paginated digital content, disabling annotations or the extra margins mode, or other suitable actions/inputs as will be apparent in light of this disclosure. After the galley area is hidden (e.g., in response to a hide command or one of the previously listed actions/inputs), the method continues back at diamond 603 to determine if the paginated digital content is still being presented displayed.

Numerous variations and embodiments will be apparent in light of this disclosure. One example embodiment of the present invention provides a device including a touch screen display for displaying paginated digital content to a user and allowing user input, and a user interface including an extra margins mode, wherein in response to a reveal command performed on a page of paginated digital content, the mode is configured to expose galley area at the perimeter of and extending seamlessly from at least a portion of the page. In some cases, additional galley area is capable of being exposed in response to additional reveal commands. In some cases, the reveal command includes at least one of a drag gesture using one or more fingers, a double tap gesture, a pinch gesture using two or more fingers, and/or an inward flick gesture from near the edge of the page using a stylus. In some cases, the mode is configured to hide the exposed galley area and present the page in its original layout in response to a hide command performed on a page having an exposed galley area. In some such cases, the hide command includes at least one of a double tap gesture, a spread gesture using two or more fingers, and/or an outward flick gesture near the edge of the galley area using a stylus. In some cases, a user can write, draw, and/or annotate in the galley area using a stylus and/or one or more fingers. In some such cases, the user can continuously write, draw, and/or annotate from the page of the paginated digital content to the galley area. In some cases, an indicator is used to identify that there is content in the galley area of a page when a user turns to said page. In some cases, the device can distinguish between capacitive input and active stylus input. In some cases, the extra margins mode is user-configurable.

Another example embodiment of the present invention provides a mobile computing device including a processor, a touch screen display for displaying paginated digital content to a user and allowing user input, and a user interface including an extra margins mode executable by the processor, wherein in response to a reveal command performed on displayed paginated digital content, the mode is configured to expose a galley area, the galley area seamlessly extending a preset amount from at least a portion of the perimeter of the displayed paginated digital content and enabling a user to write continuously between the displayed paginated digital content and the exposed galley area. In some cases, the exposed galley area extends around the entirety of the displayed paginated digital content and maintains the proportions of the original displayed content. In some cases, the exposed galley area extends around the entirety of the displayed paginated digital content by the same amount in all directions. In some cases, the paginated digital content is displayed in a two page side-by-side layout when the display is in a landscape orientation and the galley area extends from the two pages around the entire two page side-by-side layout. In some such cases, the paginated digital content is displayed in a single page layout when the display is in a portrait orientation and the galley area for the single page layout is preserved from the galley area for the two page side-by-side layout.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to, in response to a reveal command performed on a page of paginated digital content, invoke an extra margins mode configured to expose galley area at the perimeter of and extending seamlessly from at least a portion of the page, and expose the galley area for the page based on the reveal command performed. In some cases, the reveal command includes at least one of a drag gesture using one or more fingers, a double tap gesture, a pinch gesture using two or more fingers, and/or an inward flick gesture from near the edge of the page using a stylus. In some cases, the mode is configured to hide the exposed galley area and present the page in its original layout in response to a hide command performed on a page having an exposed galley area. In some such cases, the hide command includes at least one of a double tap gesture, a spread gesture using two or more fingers, and/or an outward flick gesture near the edge of the galley area using a stylus. In some cases, a user can continuously write, draw, and/or annotate from the page of the paginated digital content to the galley area.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a touch screen display for displaying paginated digital content to a user and allowing user input; and
a user interface including an extra margins mode, wherein in response to a reveal command performed on a page of paginated digital content, the mode is configured to expose galley area at the perimeter of and extending seamlessly from at least a portion of the page.

2. The device of claim 1 wherein additional galley area is capable of being exposed in response to additional reveal commands.

3. The device of claim 1 wherein the reveal command includes at least one of a drag gesture using one or more fingers, a double tap gesture, a pinch gesture using two or more fingers, and/or an inward flick gesture from near the edge of the page using a stylus.

4. The device of claim 1 wherein the mode is further configured to hide the exposed galley area and present the page in its original layout in response to a hide command performed on a page having an exposed galley area.

5. The device of claim 4 wherein the hide command includes at least one of a double tap gesture, a spread gesture using two or more fingers, and/or an outward flick gesture near the edge of the galley area using a stylus.

6. The device of claim 1 wherein a user can write, draw, and/or annotate in the galley area using a stylus and/or one or more fingers.

7. The device of claim 6 wherein the user can continuously write, draw, and/or annotate from the page of the paginated digital content to the galley area.

8. The device of claim 1 wherein an indicator is used to identify that there is content in the galley area of a page when a user turns to said page.

9. The device of claim 1 wherein the device can distinguish between capacitive input and active stylus input.

10. The device of claim 1 wherein the extra margins mode is user-configurable.

11. A mobile computing device, comprising:
a processor;
a touch screen display for displaying paginated digital content to a user and allowing user input; and
a user interface including an extra margins mode executable by the processor, wherein in response to a reveal command performed on displayed paginated digital content, the mode is configured to expose a galley area, the galley area seamlessly extending a preset amount from at least a portion of the perimeter of the displayed paginated digital content and enabling a user to write continuously between the displayed paginated digital content and the exposed galley area.

12. The device of claim 11 wherein the exposed galley area extends around the entirety of the displayed paginated digital content and maintains the proportions of the original displayed content.

13. The device of claim 11 wherein the exposed galley area extends around the entirety of the displayed paginated digital content by the same amount in all directions.

14. The device of claim 11 wherein the paginated digital content is displayed in a two page side-by-side layout when the display is in a landscape orientation and the galley area extends from the two pages around the entire two page side-by-side layout.

15. The device of claim 14 wherein the paginated digital content is displayed in a single page layout when the display is in a portrait orientation and the galley area for the single page layout is preserved from the galley area for the two page side-by-side layout.

16. A computer program product comprising a plurality of instructions non-transiently encoded thereon to facilitate operation of an electronic device according to the following process:
in response to a reveal command performed on a page of paginated digital content, invoke an extra margins mode configured to expose galley area at the perimeter of and extending seamlessly from at least a portion of the page; and
expose the galley area for the page based on the reveal command performed.

17. The computer program product of claim 16 wherein the reveal command includes at least one of a drag gesture using one or more fingers, a double tap gesture, a pinch gesture using two or more fingers, and/or an inward flick gesture from near the edge of the page using a stylus.

18. The computer program product of claim 16 wherein the mode is further configured to hide the exposed galley area and present the page in its original layout in response to a hide command performed on a page having an exposed galley area.

19. The computer program product of claim 18 wherein the hide command includes at least one of a double tap gesture, a spread gesture using two or more fingers, and/or an outward flick gesture near the edge of the galley area using a stylus.

20. The computer program product of claim 16 wherein a user can continuously write, draw, and/or annotate from the page of the paginated digital content to the galley area.
